(19) United States
(12) Patent Application Publication
(10) Pub. No.: US 2014/0253814 A1
(43) Pub. Date: Sep. 11, 2014

(54) Managing Extra Space on Ultra High Definition Display Presenting High Definition Visual Content

(71) Applicants: Kazumoto Kondo, San Diego, CA (US); Brant Candelore, San Diego, CA (US); Graham Clift, Poway, CA (US); Steven Martin Richman, San Diego, CA (US); Frederick J. Zustak, Poway, CA (US)

(72) Inventors: Kazumoto Kondo, San Diego, CA (US); Brant Candelore, San Diego, CA (US); Graham Clift, Poway, CA (US); Steven Martin Richman, San Diego, CA (US); Frederick J. Zustak, Poway, CA (US)

(73) Assignee: Sony Corporation, Tokyo (JP)

(21) Appl. No.: 13/794,109

(22) Filed: Mar. 11, 2013

(51) Int. Cl. H04N 5/44

(52) U.S. Cl. CPC H04N 5/4403
USPC 348/734

(57) ABSTRACT

A UHD display presents multiple visual content windows and a control device enables a user to select which window on the TV to present visual content from the control device. The reverse may be provided for, i.e., the control device may present a user interface (UI) that the user can operate to cause visual content from a TV region selected using the control device to be sent from the TV to the control device for presentation thereon.

### FIELD OF THE INVENTION

The present application relates generally to managing extra space on ultra high definition (UHD) displays when the UHD displays present high definition (HD) visual content, such as video, graphics, still photos, web content, icons and the like.

### BACKGROUND OF THE INVENTION

High Definition (HD) displays have been introduced which have greater resolution than standard definition (SD) displays. This is achieved by increasing the pixel density from the standard 640 or 720 pixels per line, with 480 lines (720×480), to the HD 1920×1080 (for progressive and interlaced scans) 1440×1080 (for older interlaced scans). The greater resolution produces a clearer, more detailed visual presentation.

Recently, ultra high definition (UHD) displays, also called “8K” displays, have been introduced with even greater resolution than HD. As understood herein, owing to the paucity of programming available for UHD, current UHD displays present HD visual content which is simply upscaled to fill the entire display. This approximation to true UHD, however, may undesirably cause image artifacts to appear. The problem gets worse as the density of displays increases, “16K” displays have been proposed and been put on display. As understood herein, there are more advantageous ways to exploit the improved capability of very high density displays to display more content to the viewer.

### SUMMARY OF THE INVENTION

A control device for controlling a TV display that is configured for presenting visual content, e.g. video, pictures and web content, in at least first and second regions on the TV simultaneously includes a processor configured for controlling a display, a transceiver controlled by the processor to send signals to the TV, and a computer readable storage medium bearing instructions executable by the processor to present on the display first and second selectors respectively correlated to the first and second regions of the TV display. The processor is configured to present on the display a visual content and responsive to a user selection of the first selector, send a command through the transceiver to the TV to present the visual content in the first region of the TV display. Also, the processor is configured to, responsive to a user selection of the second selector, send a command through the transceiver to the TV to present the visual content in the second region of the TV display but not in the first region. In some scenarios, the control device and the TV are connected to the same web service, and the control device communicates via the web service to select content for the first or second regions of the TV display.

The TV display may be an ultra high definition (UHD) display configured for presenting visual content in 2160 pixel lines or 4320 pixel lines. It should be understood that while the description in this application discusses UHD displays, even higher densities are on their way. And the inventions discussed herein would also apply to these denser displays. The control device can be embodied as a tablet computer.

The instructions can be executable by the processor to configure the processor to send to the TV, along with the command, the visual content. Or, the instructions may be executable by the processor to configure the processor to send to the TV, along with the command, an identification and link to the visual content but not the visual content itself.

In some embodiments the selectors are established by respective first and second alpha numeric descriptions of the respective first and second regions of the TV display. In other embodiments the selectors are established by first and second graphic representations of the respective first and second regions on the TV display, with the graphic representations presented on the display of the control device geometrically matching the respective regions on the TV display. In yet other embodiments, the first and second selectors are established by respective first and second finger swipe directions on the control device's display, with the display being a touch sensitive display inputting signals to the processor.

In addition to the above-summarized “flinging” of content from the control device to the TV display, content may be “flung” from the TV to the control device. Accordingly, the instructions can be executable by the processor to configure the processor to receive from the TV, responsive to a user selection of the first selector, a visual content and/or identification and link thereof being presented in the first region of the TV display such that the control device can present the visual content on the display of the control device, and to receive from the TV, responsive to a user selection of the second selector, a visual content and/or identification and link thereof being presented in the second region of the TV display.

In another aspect, a method includes presenting on a display of a control device first and second selectors, and also presenting on the control device a visual content. The method includes receiving a user selection of the first selector, and responsive to the user selection of the first selector, sending a command to a TV to present in a first region of the TV, but not in a second region of the TV, the visual content. Moreover, the method includes receiving a user selection of the second selector and responsive to the user selection of the second selector, sending a command to a TV to present in the second region of the TV, but not in the first region of the TV, the visual content.

In another aspect, an ultra high definition (UHD) display device includes a UHD display configured for presenting first and second visual contents in respective first and regions of the display. A processor is configured for controlling the UHD display to present demanded images. The processor is configured for, responsive to receipt from a control device of a first command, presenting on the UHD display the first visual content in the first region of the display but not in the second region. The UHD display device receives from the control device the first visual content and/or an identification of the first visual content. The processor is also configured for, responsive to receipt from the control device of a second command, presenting on the UHD display the second visual content in the second region of the display but not in the first region. The UHD display device receives from the control device the second visual content and/or an identification of the second visual content.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting example system in accordance with present principles;

FIG. 2 is a block diagram of an example TV;

FIG. 3 is a block diagram of an example control device embodied as a tablet computing device;

FIG. 4 is a screen shot of an example user interface (UI) that can be presented on the control device to select a region on the TV in which to present a visual content signal being shown on the control device;

FIG. 5 is a screen shot of an alternate example user interface (UI) that can be presented on the control device to select a region on the TV in which to present a visual content signal being shown on the control device;

FIG. 6 is a screen shot of an example user interface (UI) that can be presented on the control device to select a region on the TV for presentation in a full screen mode on the TV;

FIG. 7 is a screen shot of an example user interface (UI) that can be presented on the control device, showing schematically another embodiment for selecting a region on the TV in which to present a visual content signal being shown on the control device;

FIG. 8 is a screen shot of an example user interface (UI) that can be presented on the control device to select a visual content signal from a region on the TV to present on the control device;

FIG. 9 is a screen shot of an alternate example user interface (UI) that can be presented on the control device to select a visual content signal from a region on the TV to present on the control device; and

FIGS. 10 and 11 are flow charts showing logic associated with the above screen shots.

### DETAILED DESCRIPTION OF THE PREFERRED EMBODIMENT

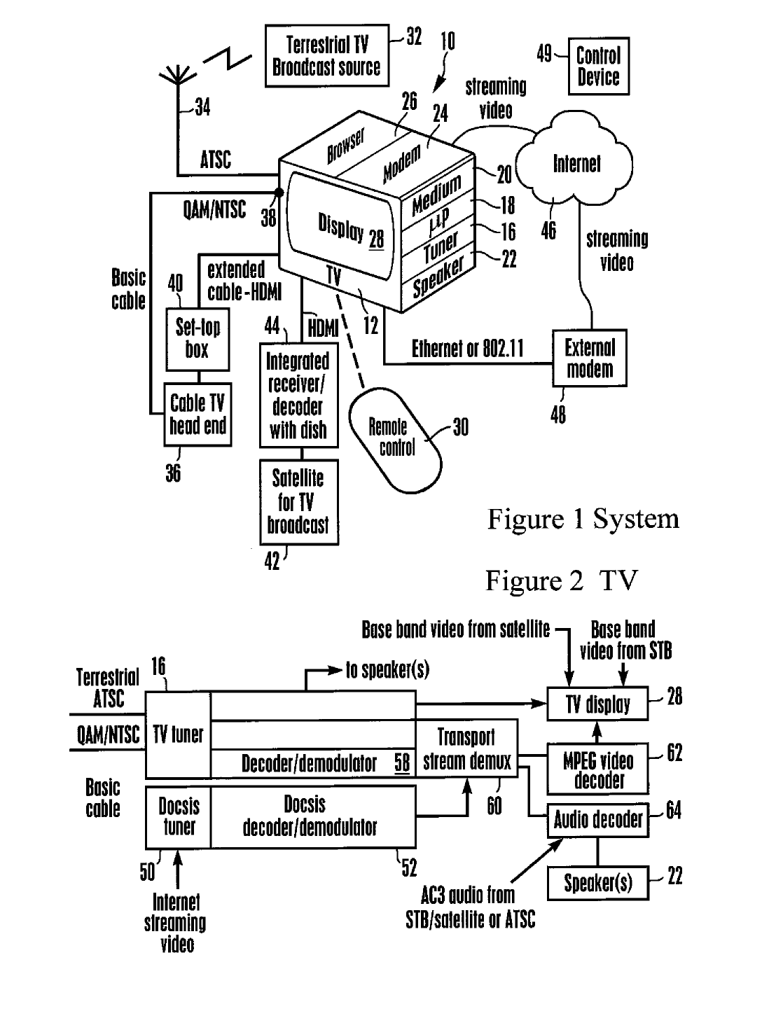

Referring initially to the non-limiting example embodiment show in FIG. 1, a system 10 includes an audio video device such as a TV 12 including a TV tuner 16 communicating with a TV processor 18 accessing a tangible computer readable storage medium 20 such as disk-based or solid state storage. The TV 12 can output audio on one or more speakers 22. The TV 12 can receive streaming visual content from the Internet using a built-in wired or wireless modem 24 communicating with the processor 12 which may execute a software-implemented browser 26. Visual content is presented under control of the TV processor 18 on a TV display 28 which according to present principles is an ultra high definition (UHD) display such as a flat panel display. The display 28 may be a 2160 p (progressive scan) display with a resolution of 3840×2160 pixels (for 4K UHD) or 4320 p (progressive scan) display with a resolution of 7860×4320 pixels (for 8K UHD). Frame rates for the UHD display 28 can be 24, 25, 50, 60, or 120 frames per second. These are exemplary numbers only.

User commands to the processor 18 may be wirelessly received from a remote control (RC) 30 using, e.g., rf or infrared. Audio-video display devices other than a TV may be used, e.g., smart phones, game consoles, personal digital organizers, notebook computers and other types of computers, etc.

TV programming from one or more terrestrial TV broadcast sources 32 as received by a terrestrial broadcast antenna 34 which communicates with the TV 12 may be presented on the display 28 and speakers 22. The terrestrial broadcast programming may conform to digital ATSC standards and may carry within it a terrestrial broadcast EPG, although the terrestrial broadcast EPG may be received from alternate sources, e.g., the Internet via Ethernet, or cable communication link, or satellite communication link.

TV programming from a cable TV head end 36 may also be received at the TV for presentation of TV signals on the display 28 and speakers 22. When basic cable only is desired, the cable from the wall typically carries TV signals in QAM format and is plugged directly into the “F-type connector” 38 on the TV chassis in the U.S., although the connector used for this purpose in other countries may vary. In contrast, when the user has an extended cable subscription for instance, the signals from the head end 36 are typically sent through a STB 40 which may be separate from or integrated within the TV chassis but in any case which sends HDMI baseband signals to the TV.

Similarly, HDMI baseband signals transmitted from a satellite source 42 of TV broadcast signals received by an integrated receiver/decoder (IRD) 44 associated with a home satellite dish may be input to the TV 12 for presentation on the display 28 and speakers 22. Also, streaming visual content may be received from the Internet 46 for presentation on the display 28 and speakers 22. The streaming visual content may be received at the computer modem 24 or it may be received at an in-home modem 48 that is external to the TV 12 and conveyed to the TV 12 over a wired or wireless Ethernet link and received at an RJ45 or 802.11x antenna on the TV chassis.

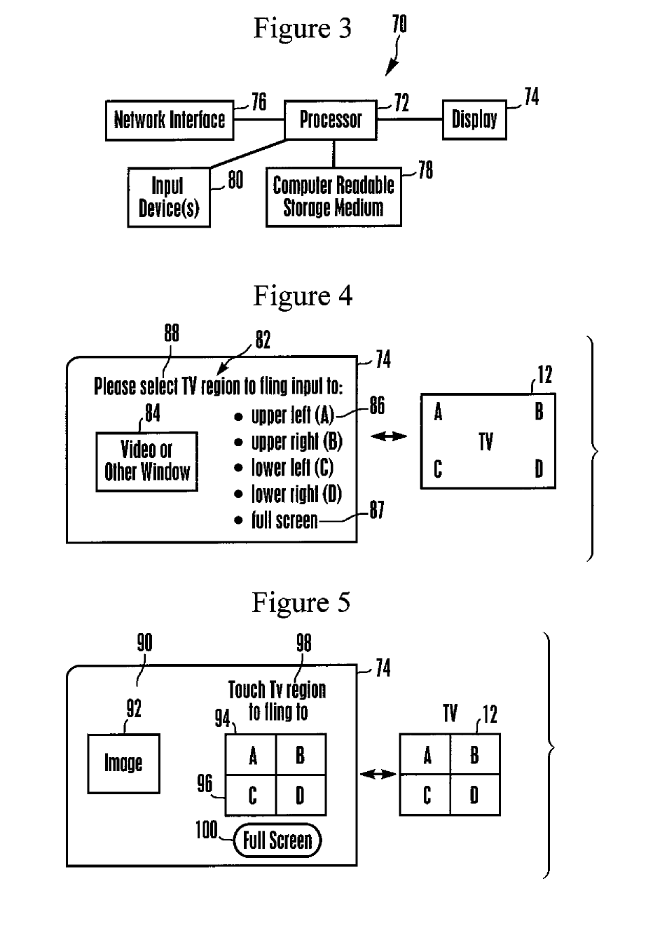

A control device 49 may be in wired or wireless communication with the TV 12 for purposes divulged further below. Further details of an example control device 49 are discussed in relation to FIG. 3.

But first, FIG. 2 shows details of an example TV 12. As shown, the terrestrial signal in ATSC format is input to the TV tuner 16, as is basic cable in NTSC or QAM format in the event that basic cable is used and the wall cable plugged into the F-type connector 38. On the other hand, streaming Internet visual content, e.g. video or web pages, may be received at a DOCSIS tuner 50 and demodulated/decoded at a DOCSIS decoder/demodulator 52. Typically, the DOCSIS components are housed separately from the TV 12 but in some embodiments may be included in the chassis of the TV 12.

The following discusses visual content that is an MPEG video stream. The output of the tuner 16, depending on the signal format received, may be sent to an appropriate decoder/demodulator 58 the output of which typically is sent to a transport stream demultiplexer 60, which separates the desired program from other programs in the selected stream and sends the desired program to an MPEG video decoder 62, which in turn uncompresses the MPEG desired program and sends the uncompressed program to the TV display 28 for presentation. Audio from the demultiplexer 60 may be sent to an audio decoder 64 which in turn sends the decoded audio to the speakers 22 for presentation.

In contrast to the sequence of decoder/demodulators, demultiplexer, and MPEG decoders discussed above, video from either the STB 40 or IRD 44 is in baseband HDMI when it is received by the TV 12. Accordingly, the signals from the STB 40 or IRD 44 are sent directly to the TV display 28 for presentation without further video decompression between the STB 40 or IRD 44 and TV display 28. Audio from the STB 40 or IRD 44 may still be in a format, e.g., AC3, that requires decoding prior to play on the speakers 22 so the audio may be sent through the audio decoder 64 as shown. Likewise, audio from the ATSC terrestrial source 32 may be in AC3 format and so may be sent through the audio decoder 64. Internet visual content, e.g. video, from the DOCSIS decoder/demodulator 52 may be sent through the demultiplexer 60 and decoders 62, 64 as shown.

Now referring to FIG. 3, an example control device is shown embodied as a tablet computer 70 with one or more processors 72 controlling one or more visual content displays 74 such as touch screen displays. The processor can communicate with the TV 12 direct (point to point) or over a network (such as a home entertainment network or the Internet) using one or more network interfaces 76 such as WiFi transceivers, Bluetooth transceivers, wireless telephony transceivers, wired modems, etc. The processor 72 can access one or more computer readable storage media 78 such as disk-based or solid state storage to execute logic described below, and can receive user commands (in addition to touch signals on the display 74) from input devices 80 such as keypads, keyboards, mice, etc. Other instantiations of control devices may be used, e.g., wireless telephones, ebooks, personal digital assistants, portable computers in general.

FIG. 4 shows a UI 82 that can be presented on the display 74 of the control device 49. As shown, a window 84 that encompasses less than the entire display 74 may be presented in which visual content is shown. The source of the visual content may be from the Internet, from internal storage in the control device 49, from a TV signal source such as a terrestrial broadcaster or cable head end, etc. The visual content may be a game or a live or taped TV video program, a web page containing, or photograph or other visual content.

Also, a selector is provided from which a user of the control device 49 can select a region of the TV 12 in which to present the visual content in the window 84. This reflects the fact that large TV displays particularly of UHD design have sufficient “real estate” (display area) and sufficient resolution to enable multiple windows of visual content to be presented simultaneously on the TV in their own respective TV windows. As an example, FIG. 4 shows that the TV 12 is divided into quadrants such that a first video program may be presented in an upper left quadrant of the TV display, labeled quadrant “A” in FIG. 4, a second video program or web page may be presented in an upper right quadrant of the TV display, labeled quadrant “B” in FIG. 4, a third source of visual content, e.g. a PEG image, may be presented in a lower left quadrant of the TV display, labeled quadrant “C” in FIG. 4, and a fourth source of visual content, email, may be presented in a lower right quadrant of the TV display, labeled quadrant “D” in FIG. 4. However, multiple presentations may be presented on the TV with greater or fewer windows and some windows may be larger than other windows, so the four quadrant layout discussed herein is exemplary only.

In the embodiment shown in FIG. 4, the selector that is presented on the display 74 of the control device 49 includes a list of alpha-numeric descriptors 86 of the TV regions A-D, one selector 86 per region of the TV. Thus, a first selector names both the TV region and in this case region letter (upper left, region “A”) to which it pertains, the second selector names “region B” as being “upper right”, and so on. A prompt 88 may be presented telling the user that selection of a selector 86 causes visual content in the window 84 of the control device 49 to be “flung”, i.e., to be caused to be presented, in the corresponding region on the TV. Selection of a selector 86 may be done by, for example, touching the selector on the display 74 or by clicking on a selector using a point and click device or by voice selection using a voice recognition algorithm. Note that a “full screen” selector 87 may be provided that can be selected to cause the visual content in the window 84 of the control device 49 to be presented in a full screen mode on the TV 12, i.e., to be presented in a mode in which a single visual content encompasses substantially the entire display area of the TV 12.

FIG. 5 shows an alternate UI 90 that may be used in lieu of the UI 82 shown in FIG. 4. As shown, a window 92 that encompasses less than the entire display 74 may be presented in which visual content is shown. The source of the visual content may be from the Internet, from internal storage in the control device 49, from a TV signal source such as a terrestrial broadcaster or cable head end, etc. The visual content may be a game or a live or taped TV visual content program or photograph or other visual content.

Also, a selector is provided from which a user of the control device 49 can select a region of the TV 12 in which to present the visual content in the window 92. Assume for exposition that four TV regions are envisioned as before, it being understood that two, three, or more regions, potentially of different shapes and sizes, may be used on the TV instead of the four quadrant example shown.

In the embodiment shown in FIG. 5, the selector that is presented on the display 74 of the control device 49 includes a graphic mirror of the regions on the TV 12, in this case, four selectors 94 graphically arranged as quadrants of a display and optionally presenting respective alpha-numeric indicators 96 of the respective TV region. Thus, for each region on the TV, a respective graphic representation is provided on the control device 49, one selector 94 per region of the TV. Note further that the graphic representations of the selectors 94 can geometrically match the regions on the TV, so that the selector 94 representing the upper left quadrant presentation window of the TV 12 appears as the upper left quadrant in the graphic representation on the control device 49, and so on.

A prompt 98 may be presented telling the user that selection of a selector 94 causes visual content in the window 92 of the control device 49 to be “flung”, i.e., to be caused to be presented, in the corresponding region on the TV. Note that a “full screen” selector 100, in this case in the form of a graphic button, may be provided that can be selected to cause the visual content in the window 92 of the control device 49 to be presented in a full screen mode on the TV 12, i.e., to be presented in a mode in which a single visual content encompasses substantially the entire display area of the TV 12.

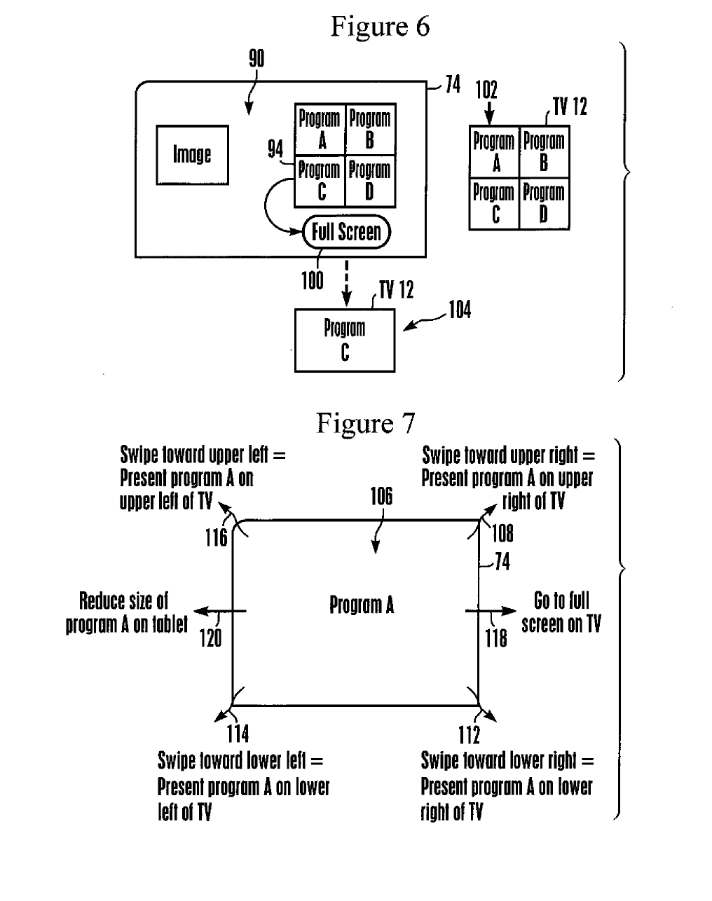

FIG. 6 illustrates that with the TV 12 in the multi-window mode as shown at 102, responsive to selection of one of the region selectors 94, in the example shown, the selector 94 for region C, and the simultaneous or immediately sequential selection of the full screen selector 100, the control device 49 sends to the TV 12 a command to assume a full screen mode, shown at 104 in FIG. 6. In the full screen mode the entire display of the TV 12 is encompassed by the visual content formerly confined to the (relatively) small region on the TV in which the content had been shown in the multi-window mode 102 and which was represented by the user-selected selector 94 on the control device.

FIG. 7 shows an alternate embodiment in which a UI 106 is presented on the control device display 74 presenting at least one visual content represented by the title “PGM A” in FIG. 7. To “fling” this content onto the TV 12, the user of the control device 49 uses a finger swipe, with respective swipe directions corresponding to respective display commands to the TV 12. In the non-limiting example shown, a finger swipe toward the upper right hand corner of the display 74 (represented by arrow 108) sends the visual content on the control device 49 to the TV 12 for display, and signals that the visual content is to be presented in an upper right quadrant of the TV 12 in a multi-window mode in which multiple visual contents are presented simultaneously on the TV 12 in respective windows. If desired, the alpha numeric message 110 representing a description of the above command may be presented on the display 74 for the user's convenience, although for clarity the message 110 is shown off-display in FIG. 7.

On the other hand, a finger swipe toward the lower right hand corner of the display 74 (represented by the arrow 112) sends the visual content on the control device 49 to the TV 12 for display, and signals that the visual content is to be presented in a lower right quadrant of the TV 12 in the multi-window mode. An alpha numeric message representing a description of the above command may be presented on the display 74 for the user's convenience, although for clarity the message is shown off-display in FIG. 7.

Yet again, a finger swipe toward the lower left hand corner of the display 74 (represented by the arrow 114) sends the visual content on the control device 49 to the TV 12 for display, and signals that the visual content is to be presented in a lower left quadrant of the TV 12 in the multi-window mode. An alpha numeric message representing a description of the above command may be presented on the display 74 for the user's convenience, although for clarity the message is shown off-display in FIG. 7.

Still further, a finger swipe toward the upper left hand corner of the display 74 (represented by the arrow 116) sends the visual content on the control device 49 to the TV 12 for display, and signals that the visual content is to be presented in an upper left quadrant of the TV 12 in the multi-window mode. An alpha numeric message representing a description of the above command may be presented on the display 74 for the user's convenience, although for clarity the message is shown off-display in FIG. 7.

In addition to the above examples for flinging content on the control device 49 to the TV 12, additional finger swipes may be used for further purposes. For example, as indicated by the arrow 118, a finger swipe substantially straight across the display 74, toward the right edge thereof, can command the TV to present the content on the control device 49 in the full screen mode of the TV. An alpha numeric message representing a description of the above command may be presented on the display 74 for the user's convenience, although for clarity the message is shown off-display in FIG. 7. And as indicated by the arrow 120, a finger swipe substantially straight across the display 74, toward the left edge thereof, can command the control device processor to reduce the depiction of the visual content on the control device to a smaller window similar to the four quadrant windows shown in FIG. 6, for example. An alpha numeric message representing a description of the above command may be presented on the display 74 for the user's convenience, although for clarity the message is shown off-display in FIG. 7.

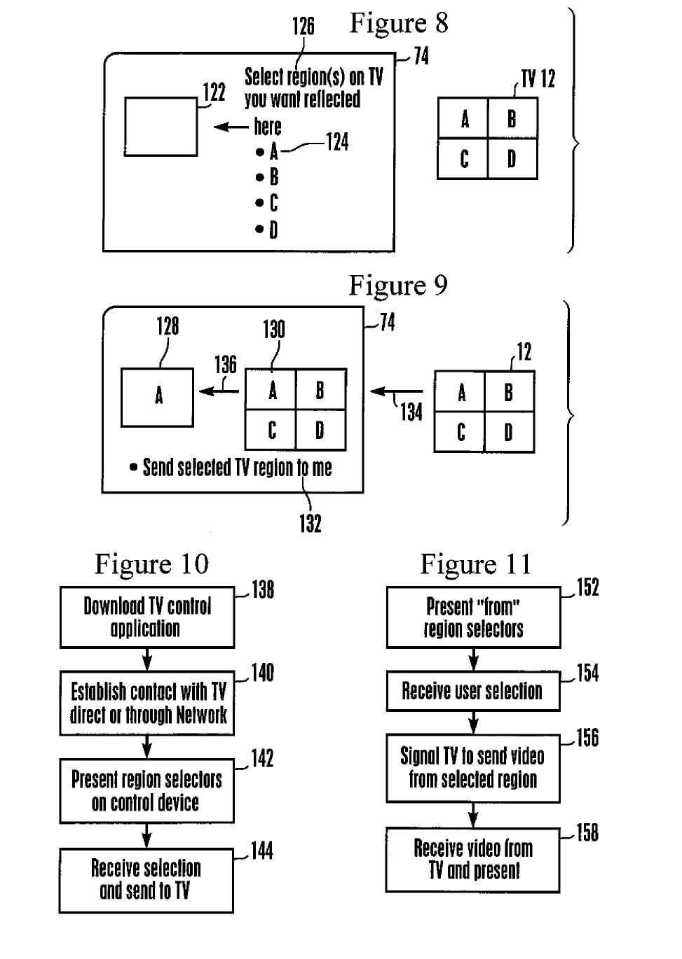

FIGS. 8 and 9 show example embodiments for “flinging” visual content from the TV to the control device 49. In FIG. 8, a window 122 that encompasses less than the entire display 74 may be presented in which visual content can be shown. Also, a selector is provided from which a user of the control device 49 can select a region of the TV 12 from which to present the visual content in the window 122. As an example, FIG. 8 shows that the TV 12 is divided into quadrants such that a first visual content may be presented in an upper left quadrant of the TV display, labeled quadrant “A” in FIG. 4, a second visual content may be presented in an upper right quadrant of the TV display, labeled quadrant “B” in FIG. 4, a third visual content may be presented in a lower left quadrant of the TV display, labeled quadrant “C” in FIG. 4, and a fourth visual content may be presented in a lower right quadrant of the TV display, labeled quadrant “D” in FIG. 4. However, multiple presentations may be presented on the TV with greater or fewer windows and some windows may be larger than other windows, so the four quadrant layout discussed herein is exemplary only.

In the embodiment shown in FIG. 8, the selector that is presented on the display 74 of the control device 49 includes a list of alpha-numeric descriptors 124 of the TV regions A-D, one selector 124 per region of the TV. Thus, a first selector names both the TV region and in this case region letter (upper left, region “A”) to which it pertains, the second selector names “region B” as being “upper right”, and so on. A message prompt 126 may be presented telling the user that selection of a selector 124 causes visual content in the selected region of the TV 12 to be “flung”, i.e., to be caused to be presented, in the window 122 of the control device 12. Selection of a selector 124 may be done by, for example, touching the selector on the display 74 or by clicking on a selector using a point and click device or by voice selection using a voice recognition algorithm. Responsive to selection of a selector 124, the control device 49 commands the TV 12 to send to the control device 49 the visual content being presented on the TV 12 in the region corresponding to the region represented by the selected selector 124.

FIG. 9 shows an alternate UI that may be used in lieu of the UI shown in FIG. 8. As shown, a window 128 that encompasses less than the entire display 74 may be presented in which visual content can be shown. Also, a selector is provided from which a user of the control device 49 can select a region of the TV 12 from which to present the visual content in the window 128. Assume for exposition that four TV regions are envisioned as before, it being understood that two, three, or more regions, potentially of different shapes and sizes, may be used on the TV instead of the four quadrant example shown.

In the embodiment shown in FIG. 9, the selector that is presented on the display 74 of the control device 49 includes a graphic mirror of the regions on the TV 12, in this case, four selectors 130 graphically arranged as quadrants of a display and optionally presenting respective alpha-numeric indicators of the respective TV region. Thus, for each region on the TV, a respective graphic representation is provided on the control device 49, one selector 130 per region of the TV. Note further that the graphic representations of the selectors 130 can geometrically match the regions on the TV, so that the selector 130 representing the upper left quadrant presentation window of the TV 12 appears as the upper left quadrant in the graphic representation on the control device 49, and so on.

A prompt 132 may be presented telling the user that selection of a selector 130 causes visual content in the selected region of the TV 12 to be presented in the window 128 of the control device 49. Accordingly, selection of, e.g., the selector 130 on the control device 49 representing a corresponding quadrant on the TV 12 causes visual content in that quadrant of the TV 12 to be sent, as indicated by the arrow 134, to the control device 49 for presentation thereof as indicated by the arrow 136 in the window 128.

In the above scenarios, whether content is “flung” from the control device 49 to the TV 12 or vice-versa, the actual transmission of visual content may be direct between the devices using an appropriate wireless protocol, e.g., Bluetooth, WiFi Direct, or a wireless telephony protocol. Or, the visual content may not be transmitted direct from device to device. In lieu of transmission, the device onto which content is to be “flung”, say the TV 12, may be provided by the control device 49 or by a third party provisioning device with a visual content source identifier such as a wide area network address of a steaming visual content course from which the content can be obtained or with a TV channel number to tune to, etc.

FIGS. 10 and 11 are flow charts exemplifying logic associated with the above description. Commencing at block 138 in FIG. 10, if the control device 49 does not have an application for executing the principles discussed above, it downloads one (usually responsive to a user command to do so) from a source of applications, typically an Internet server. The application contains instructions regarding the UI to be presented on the control device. For example, a user may enter a model number, serial number, or other identification of the TV to obtain in response an application tailored for the visual content region layout(s) of that TV. The application contains information as to the number and configuration of the various visual content regions of the TV so that the UI presented on the control device presents corresponding selectors, typically on a one for one basis, associated with respective display regions on the TV.

Moving to block 140 the control device 49 establishes communication with the TV 12 either directly or through a network as described above. At block 142 the control device 49 presents on its display 74 a selector member such as one of those described above for selecting a region of the TV in which the user desires visual content presented on the control device 49 to appear. User selections are received by the control device 49 and sent to the TV 12 at block 144. As described above, visual content on the control device 49 may be sent direct from the control device 49 to the TV 12 for presentation thereof in the selected region of the TV, or the TV 12 may source the selected content from elsewhere, e.g., a TV signal source or an Internet server, for presenting the selected content in the selected region of the TV.

FIG. 11 illustrates example logic for the “reverse” flinging of visual content from the TV to the control device. At block 146 the control device 49 presents on its display 74 a selector member such as one of those described above for selecting a region of the TV from which the user desires visual content to be presented on the control device 49. User selections are received by the control device 49 at block 148 and sent to the TV 12 at block 150. As described above, visual content in the selected region on the TV 12 may be sent direct from TV 12 to the control device 49 for presentation thereof on the display 74 of the control device 49 at block 150.

While the particular MANAGING EXTRA SPACE ON ULTRA HIGH DEFINITION DISPLAY PRESENTING HIGH DEFINITION VISUAL CONTENT is herein shown and described in detail, it is to be understood that the subject matter which is encompassed by the present invention is limited only by the claims.

What is claimed is:

1. A control device for controlling a TV display configured for presenting visual content in at least first and second regions on the TV simultaneously, comprising:
processor configured for controlling a display;
transceiver controlled by the processor to send signals to the TV; and
computer readable storage medium bearing instructions executable by the processor to:
present on the control device first and second selectors respectively correlated to the first and second regions of the TV display;
present on the display a visual content;
responsive to a user selection of the first selector, send a command through the transceiver to the TV to present the visual content in the first region of the TV display; and
responsive to a user selection of the second selector, send a command through the transceiver to the TV to present the visual content in the second region of the TV display but not in the first region.

2. The control device of claim 1, wherein the TV display has a display resolution of at least 2160 pixel lines.

3. The control device of claim 1, wherein the control device is embodied as a tablet computer.

4. The control device of claim 1, wherein the instructions are executable by the processor to configure the processor to send to the TV, along with the command, the visual content.

5. The control device of claim 1, wherein the instructions are executable by the processor to configure the processor to send to the TV, along with the command, an identification of the visual content but not the visual content.

6. The control device of claim 1, wherein the selectors are established by respective first and second alpha numeric descriptions of the respective first and second regions of the TV display.

7. The control device of claim 1, wherein the selectors are established by first and second graphic representations of the respective first and second regions on the TV display, the graphic representations presented on the display of the control device geometrically matching the respective regions on the TV display.

8. The control device of claim 1, wherein the first and second selectors are established by respective first and second finger swipe directions on the display, the display being a touch sensitive display inputting signals to the processor.

9. The control device of claim 1, wherein the instructions are executable by the processor to configure the processor to receive from the TV, responsive to a user selection of the first selector, a visual content and/or identification thereof being presented in the first region of the TV display such that the control device can present the visual content on the display of the control device, and to receive from the TV, responsive to a user selection of the second selector, a visual content and/or identification thereof being presented in the second region of the TV display.

10. Method comprising:
presenting on a display of a control device first and second selectors;
presenting on the control device a visual content;
receiving a user selection of the first selector;
responsive to the user selection of the first selector, sending a command to a TV to present in a first region of the TV, but not in a second region of the TV, the visual content;
receiving a user selection of the second selector; and
responsive to the user selection of the second selector, sending a command to a TV to present in the second region of the TV, but not in the first region of the TV, the visual content.

11. The method of claim 10, wherein the TV has a display resolution of a least visual content 2160 pixel lines pixel lines.

12. The method of claim 10, wherein the control device is embodied as a tablet computer.

13. The method of claim 10, wherein the selectors are established by respective first and second alpha numeric descriptions of the respective first and second regions of the TV.

14. The method of claim 10, wherein the selectors are established by respective first and second graphic representations of the respective first and second regions on the TV, the graphic representations presented on the display of the control device geometrically matching the respective regions on the TV.

15. The method of claim 10, wherein the first and second selectors are established by respective first and second finger swipe directions on the display of the control device.

16. The method of claim 10, comprising receiving from the TV, responsive to a user selection of the first selector, a visual content and/or identification thereof being presented in the first region of the TV such that the control device can present the visual content on the display of the control device; and
receiving from the TV, responsive to a user selection of the second selector, a visual content and/or identification thereof being presented in the second region of the TV display.

17. An ultra high definition (UHD) display device comprising:
a UHD display configured for presenting first and second visual contents in respective first and regions of the display; and
a processor configured for controlling the UHD display to present demanded images, the processor configured for:
responsive to receipt from a control device of a first command, presenting on the UHD display the first visual content in the first region of the display but not in the second region, the UHD display device receiving from the control device the first visual content and/or an identification of the first visual content; and
responsive to receipt from the control device of a second command, presenting on the UHD display the second visual content in the second region of the display but not in the first region, the UHD display device receiving from the control device the second visual content and/or an identification of the second visual content.

18. The device of claim 17, wherein the UHD display device receives the first visual content from the control device.

19. The device of claim 17, wherein the processor is configured for, responsive to a third command from the control device, sending to the control device the first visual content and/or an identification thereof.

20. The device of claim 19, wherein the processor is configured for, responsive to a fourth command from the control device, sending to the control device the second visual content and/or an identification thereof.
